(19) United States
(12) Patent Application Publication
(10) Pub. No.: US 2014/0258851 A1
(43) Pub. Date: Sep. 11, 2014

(54) Table of Contents Detection in a Fixed Format Document

(71) Applicant: MICROSOFT CORPORATION, Redmond, WA (US)

(72) Inventors: Milan Sesum, Belgrade (RS); Aljosa Obuljen, Belgrade (RS)

(73) Assignee: MICROSOFT CORPORATION, Redmond, WA (US)

(21) Appl. No.: 13/794,351

(22) Filed: Mar. 11, 2013

(51) Int. Cl. G06F 17/22

(52) U.S. Cl. CPC G06F 17/2264
USPC 715/249

(57) ABSTRACT

Detection of table of contents entries in a fixed format document for reconstruction of table of contents entries in a flow format document is provided. One or more table of contents entries are detected in a fixed format document, and table of contents entry candidates are generated by grouping one or more lines containing suspected table of contents entries. Each grouping is compared to text contained in the fixed format document for locating matching headings, subheadings, and associated text in the fixed format document. After non-matching or false positive matches are discarded, headings found in the fixed format document matching headings contained in table of contents entry candidates are used to reconstruct table of contents entries in a table of contents page, area or section in a reconstructed flow format document.

### BACKGROUND

Flow format documents and fixed format documents are widely used and have different purposes. Flow format documents organize a document using complex logical formatting objects such as sections, paragraphs, columns, and tables. As a result, flow format documents offer flexibility and easy modification making them suitable for tasks involving documents that are frequently updated or subject to significant editing. In contrast, fixed format documents organize a document using basic physical layout elements such as text runs, paths, and images to preserve the appearance of the original. Fixed format documents offer consistent and precise format layout making them suitable for tasks involving documents that are not frequently or extensively changed or where uniformity is desired. Examples of such tasks include document archival, high-quality reproduction, and source files for commercial publishing and printing. Fixed format documents are often created from flow format source documents. Fixed format documents also include digital reproductions (e.g., scans and photos) of physical (i.e., paper) documents.

In situations where editing of a fixed format document is desired but the flow format source document is not available, the fixed format document may be converted into a flow format document. Conversion involves parsing the fixed format document and transforming the basic physical layout elements from the fixed format document into the more complex logical elements used in a flow format document.

Table of contents pages, sections or areas and associated headings are common elements in many documents. For example, in a large business or educational document, text may be organized under a number of headings and subheadings distributed through the body of the document. At or near the beginning of the document, a table of contents page may be included that lists each of the headings and subheadings and typically provides a page number on which each heading or subheading and associated text or other content is located. In some cases, a table of contents page or area may also be located in other areas of a document, for example, at the end of a document, or in various places inside a document. In addition, headings that may be associated with table of contents items may be located in various places throughout a document including above and below a table of contents page or area. In addition, some documents may have multiple tables of contents pages where a small table of contents page may list only a high level subset of headings and/or subheadings and where a larger table of contents page may list a full set of all headings and subheadings contained in the document.

Currently, when converting a fixed format document that contains a table of contents into a flow format document, the table of contents page, section or area and the items comprising the table of contents are not recognized, and thus, when the fixed format document is converted, page numbers associated with table of contents items will not be correct in the converted document. That is, the page numbers in the table of contents (typically at the end of each table of content item) will not be correct after conversion (owing to reflow of the converted document), and thus, it will be difficult to update the converted document. In addition, during document conversion, table of contents items sometimes will be sometimes into single paragraphs (owing to erroneous paragraph detection), and thus, the reconstructed table of contents page, section or area in the flow format document will not look the same as the pre-converted fixed format document.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing detection of table of contents entries in a fixed format document and reconstructing detected table of contents entries in a flow format document. After detection of table of contents entries in a table of contents page, section or area of a fixed format document, the detected entries are used to improve detection of headings in the fixed format document, for example, by finding headings on pages in the fixed format document corresponding to page numbers associated with detected table of contents entries. During reconstruction of the fixed format document into a flow format document, the detected table of contents page, section or area may be replaced with a single “smart field” which may, in turn, be populated with headings collected from the fixed format document to create a reconstructed table of contents page, section or area.

Embodiments provide for searching for lines in a fixed format document that have attributes of table of contents entries, for example, headings, space separators and page numbers. Table of contents entry candidates are generated by collecting such possible table of contents entry lines along with lines occurring before and after the possible table of contents entry lines into table of contents candidate groupings. Each grouping is then compared to text in the fixed format document to find matches of table of contents candidates with headings or subheadings in the fixed format document.

After non-matching and/or false positive table of contents candidates are discarded, those table of contents candidates detected to be correct table of contents entries are used for reconstruction a table of contents page, area, or section in a flow format document.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system including a document converter;

FIG. 2 is a block diagram showing an operational flow of one embodiment of a document processor;

FIG. 3A is an illustration of a table of contents page in a fixed format document;

FIG. 3B is an illustration of headings and text in the body of a fixed format document;

FIG. 3C is an illustration of headings and text in the body of a fixed format document;

FIGS. 4A, 4B, 4C illustrate a flow chart of a method for detecting table of contents entries in a fixed format document for reconstructing a table of contents page, section, or area in a flow format document;

FIG. 5 is a block diagram illustrating example physical components of a computing device with which embodiments of the invention may be practiced;

FIGS. 6A and 6B are simplified block diagrams of a mobile computing device with which embodiments of the present invention may be practiced; and

FIG. 7 is a simplified block diagram of a distributed computing system in which embodiments of the present invention may be practiced.

### DETAILED DESCRIPTION

As briefly described above, embodiments of the present invention are directed to providing detection of table of contents entries in a fixed format document and reconstructing detected table of contents entries in a flow format document. After detection of table of contents (sometimes referred to as TOC) entries in a table of contents page, section or area of a fixed format document, the detected entries are used to improve detection of headings in the fixed format document, for example, by finding headings on pages in the fixed format document corresponding to page numbers associated with detected table of contents entries. During reconstruction of the fixed format document into a flow format document, the detected table of contents page, section or area may be replaced with a single “smart field” which may, in turn, be populated with headings collected from the fixed format document to create a reconstructed table of contents page, section or area.

According to embodiments, one or more table of contents entries are detected in a fixed format document, and table of contents entry candidates are generated by grouping one or more lines containing suspected table of contents entries. Each grouping is compared to text contained in the fixed format document for locating matching headings, subheadings, and associated text in the fixed format document. After non-matching or false positive matches are discarded, table of contents entry candidates detected to be correct table of contents entries are used detect headings contained in the fixed format document. Detected headings are collected, and then during reconstruction of the flow format document, the detected TOC page, section or area is replaced with a single TOC smart field. The TOC smart field may then be populated with the detected headings to create a TOC page, section or area in the reconstructed flow format document.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

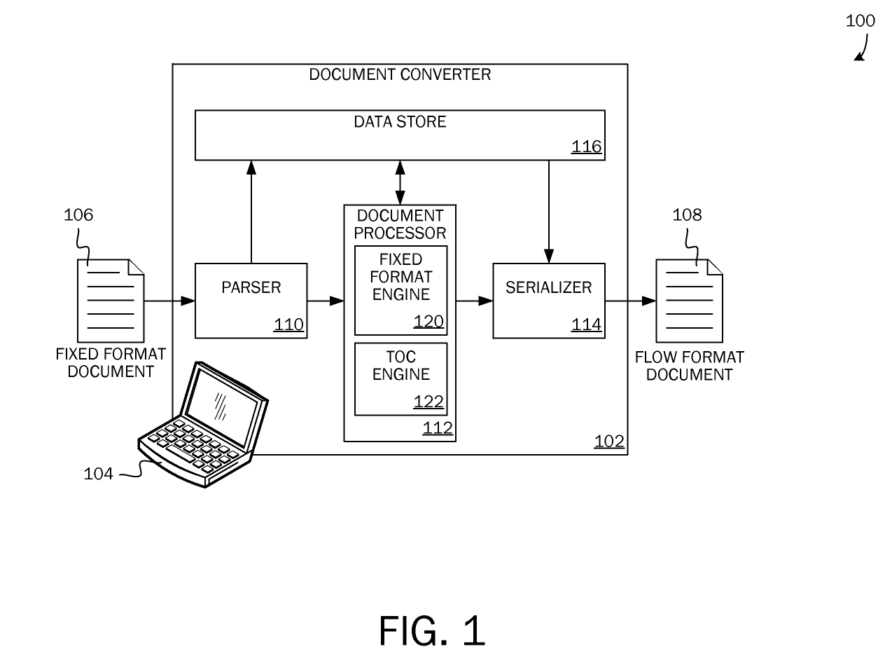

Referring now to the drawings, in which like numerals represent like elements, various embodiments will be described. FIG. 1 illustrates one embodiment of a system 100 incorporating a fixed format detection and flow format reconstruction engine 120 and a table of contents detection and reconstruction engine 122. According to embodiments, the fixed format detection and flow format reconstruction engine 120 may include a software module operative to locate lines, paragraphs and other objects of a fixed format document for reconstructing content from a fixed format document into a flow format document. For more information on detection of lines, paragraphs and other objects of a fixed format document for reconstructing content from a fixed format document into a flow format document, see U.S. patent application Ser. No. 13/521,378, filed Jul. 10, 2012, titled “Fixed Format Document Conversion Engine,” U.S. patent application Ser. No. 13/521,407, filed Jul. 10, 2012, titled “Paragraph Property Detection and Style Reconstruction Engine,” and Unites States patent application Ser. No. 13/808,052, filed Jan. 2, 2013 titled “Multi-Level List Detection Engine, each of which are incorporated herein by reference as if fully set out herein. The table of contents detection and reconstruction engine 122 may include a software module operative to detect table of contents entries and associated headings, subheadings and text in a fixed format document for reconstructing table of contents entries in a flow format document.

In the illustrated embodiment, the fixed format detection and flow format reconstruction engine 120 and the table of contents detection and reconstruction engine 122 may operate as part of a document converter 102 executed on a computing device 104. The document converter 102 converts a fixed format document 106 into a flow format document 108 using a parser 110, a document processor 112, and a serializer 114. The parser 110 reads and extracts data from the fixed format document 106. The data extracted from the fixed format document is written to a data store 116 accessible by the document processor 112 and the serializer 114. The document processor 112 analyzes and transforms the data into flowable elements using one or more detection and/or reconstruction engines. Finally, the serializer 114 writes the flowable elements into a flowable document format (e.g., a word processing format).

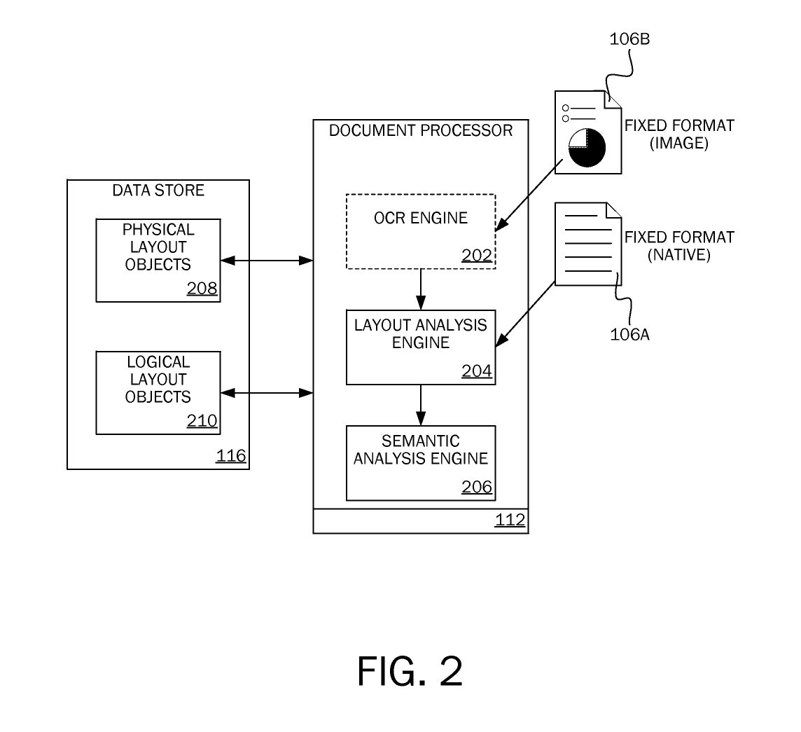

FIG. 2 illustrates one embodiment of the operational flow of the document processor 112 in greater detail. The document processor 112 includes an optional optical character recognition (OCR) engine 202, a layout analysis engine 204, and a semantic analysis engine 206. The data contained in the data store 116 includes physical layout objects 208 and logical layout objects 210. In some embodiments, the physical layout objects 208 and logical layout objects 210 are hierarchically arranged in a tree-like array of groups (i.e., data objects). In various embodiments, a page is the top level group for the physical layout objects 208, while a section is the top level group for the logical layout objects 210. The data extracted from the fixed format document 106 is generally stored as physical layout objects 208 organized by the containing page in the fixed format document 106. The basic physical layout objects 208 include text-runs, images, and paths. Text-runs are the text elements in page content streams specifying the positions where characters are drawn when displaying the fixed format document. Images are the raster images (i.e., pictures) stored in the fixed format document 106. Paths describe elements such as lines, curves (e.g., cubic Bezier curves), and text outlines used to construct vector graphics. Logical layout objects 210 include flowable elements such as sections, paragraphs, tables, and lists.

Where processing begins depends on the type of fixed format document 106 being parsed. A native fixed format document 106A may be created directly from a flow format source document and may contain some or all of the basic physical layout elements. Alternatively, a native fixed format document 106A may be created directly with an appropriate application that allows for creation of a fixed format document as an original document. The embedded data objects are extracted by the parser and are available for immediate use by the document converter; although, in some instances, minor reformatting or other minor processing is applied to organize or standardize the data. In contrast, all information in an image-based fixed format document 106B created by digitally imaging a physical document (e.g., scanning or photographing) is stored as a series of page images with no additional data (i.e., no text-runs or paths). In this case, the optional optical character recognition engine 202 analyzes each page image and creates corresponding physical layout objects. Once the physical layout objects 208 are available, the layout analysis engine 204 analyzes the layout of the fixed format document. After layout analysis is complete, the semantic analysis engine 206 enriches the logical layout objects with semantic information obtained from analysis of the physical layout objects and/or logical layout objects.

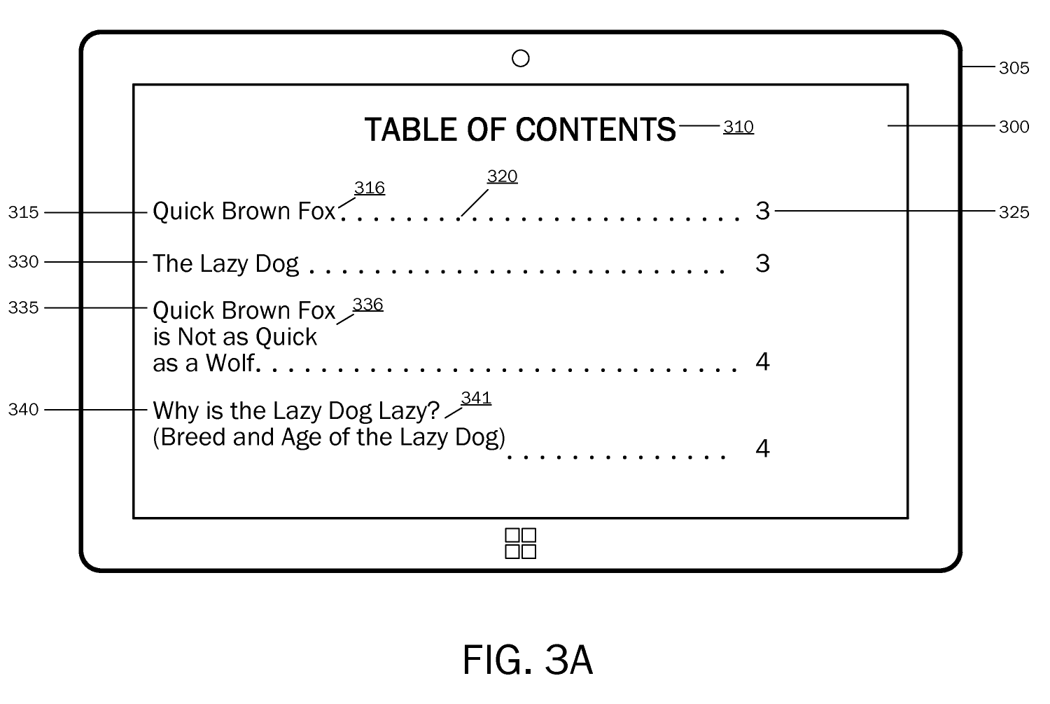

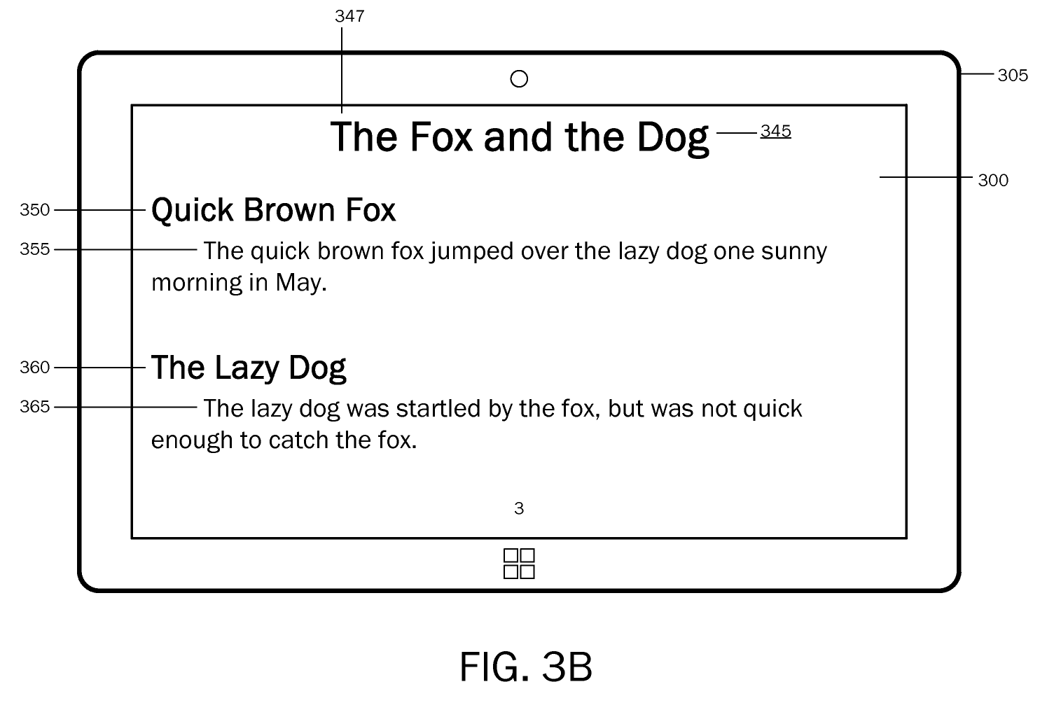

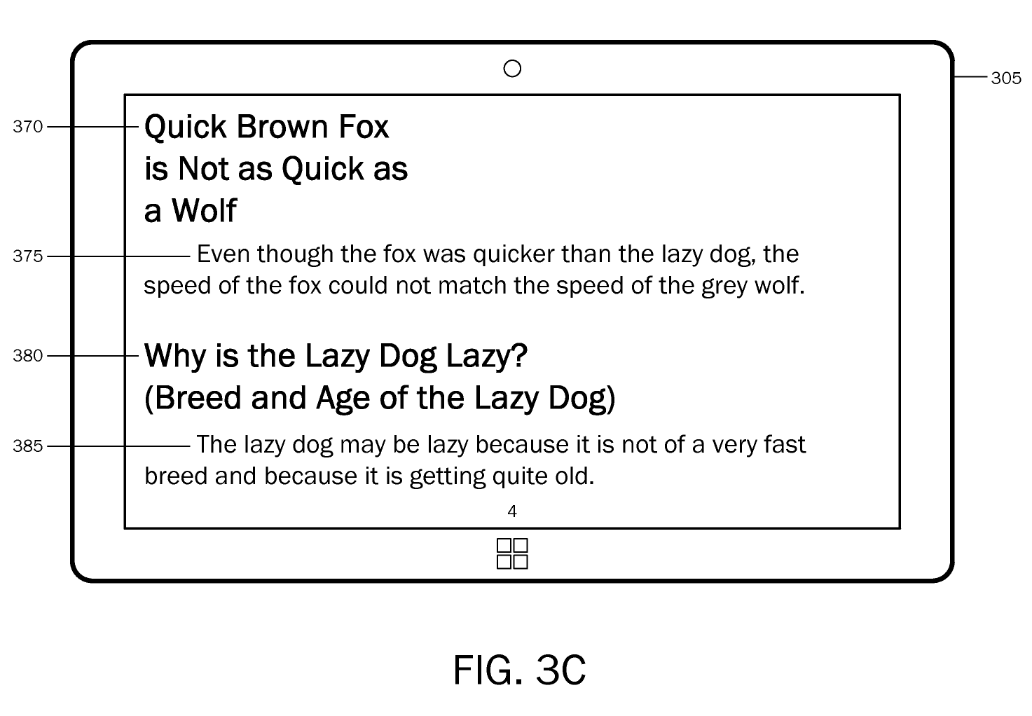

As illustrated in FIG. 3A, a table of contents page 300 of an associated fixed format document 106 is illustrated as being displayed on a display surface of a tablet-style computing device 305. As should be appreciated, the tablet-style computing device 305 is but one example of any suitable computing device and associated display on which a fixed format document may be displayed and on which a converted flow format document may be displayed according to embodiments of the present invention.

Referring still to FIG. 3A, a table of contents title or heading 310 is illustrated with the text “Table of Contents.” In addition, four example table of contents entries 315, 330, 335, 340 are illustrated on the table of contents page 300 beneath the table of contents title 310. As illustrated in FIG. 3A, one or more line spaces are included between each of the table of contents entries 315, 330, 335, 340, but as should be appreciated, no line spacing may be included between each of the table of content entries.

Referring to the table of contents entry 315, a heading 316 of “Quick Brown Fox” is illustrated, followed by one or more space separators 320, followed by a page number 325. The illustrated table of contents entry 315 is typical of one or more table of contents entries that may be included in a table of contents page, section, or area of a given document. As should be appreciated, in some instances a table of contents entry may include a table of contents heading 316 followed by different types of space separators 320, for example, the dots illustrated in FIG. 3A, or blank spaces, or other visual indicators of space between the end of the heading 316 and the displayed page number 325.

As should be appreciated, the example table of contents entries illustrated in FIG. 3A are illustrated in a left-to-right orientation associated with languages, for example, English, in which text is entered and displayed in a left-to-right orientation. As should be appreciated, if the table of contents entries illustrated in FIG. 3A are displayed according to a right-to-left orientation, for example, according to a language such as Arabic, then the headings 316, 336, 341 would be displayed on the right side of the table of contents page 300, and the page numbers associated with text or headings related to the table of contents entries would be displayed along the left side of the page. In addition, one or more space separators (dots, spaces, other visual indicators) may be displayed between the table of contents headings and the associated page numbers.

The page number 325 displayed for the table of contents entry indicates a page number in the associated document on which the heading 316 and/or associated text may be located. That is, following the example illustrated in FIG. 3A, the page number “3” indicates that the heading 316 “Quick Brown Fox” and associated text are located on page 3 of the fixed format document associated with the table of contents page 300. In a typical setting, the heading 316 and associated text will be placed on the page of the document indicated by the page number at the end of the table of contents entry. However, in some instances, a document may be structured such that text associated with the table of contents entry is located on the indicated page number, but the heading 315 may be omitted as desired by the author of the associated document.

Referring still to FIG. 3A, the table of contents entries 315, 330 are illustrated as single lines in the table of contents page 300. However, the table of contents entries 335 and 340 are illustrated as multi-line table of contents entries. For example, the table of content entry 335 includes three lines of heading text “Quick Brown Fox Is Not As Quick As A Wolf,” and the page number is illustrated at the end of the third line of the heading 336. Similarly, for the table of contents entry 340, a two line heading 341 is included, and the page number is indicated at the end of the second line of the heading 341.

Referring now to FIG. 3B, a page of text from a fixed format document 106 associated with the table of contents page 300 is illustrated as displayed on the tablet-style computing device 305. The text page 345 includes an example document title 347, a first heading 350, a text selection 355, a second heading 360, and a second text selection 365. According to an embodiment, the headings and text selections illustrated in FIG. 3B are associated with table of contents entries 315 and 330, respectively, illustrated and described above with reference to FIG. 3A. The text selection 355 is an example of text in the body of the fixed format document 345 being displayed underneath and in association with the heading 350, and the text selection 365 is illustrative of a text selection displayed underneath and associated with the heading 360. Referring to FIG. 3C, headings 370 and 380 are illustrated and are associated with table of contents entries 335, 340, respectively, and text selections 375 and 385 are illustrated as displayed beneath the headings 370 and 380, respectively.

As briefly described above, in some instances, table of contents entries may be “smart fields” wherein table of contents entries 315, 330, 335, 340 in a table of contents page, section or area may be linked to associated headings 350, 360, 370, 380 in the associated document. Thus, if the associated document is edited such that information in the document linked to associated table of contents entries changes, those changes may be reflected in the table of contents entries displayed in the table of contents page, section or area. For example, if the example document illustrated in FIGS. 3B and 3C is edited such that the heading 360 is moved from page 3 to page 4, then the page number illustrated for the table of contents entry 330 in FIG. 3A may be dynamically changed from page 3 to page 4. Likewise, if the text of the heading 360, illustrated in FIG. 3B, is edited, the associated text in the table of contents entry 330 may be dynamically changed so that the heading in the table of contents entry 330 will match the corresponding heading 360 displayed in the document 345.

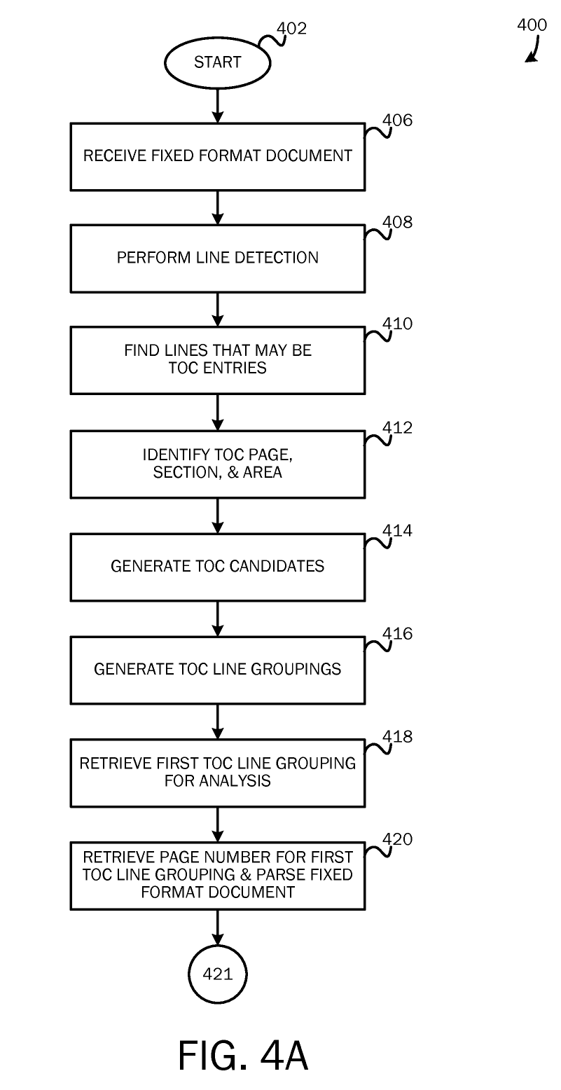

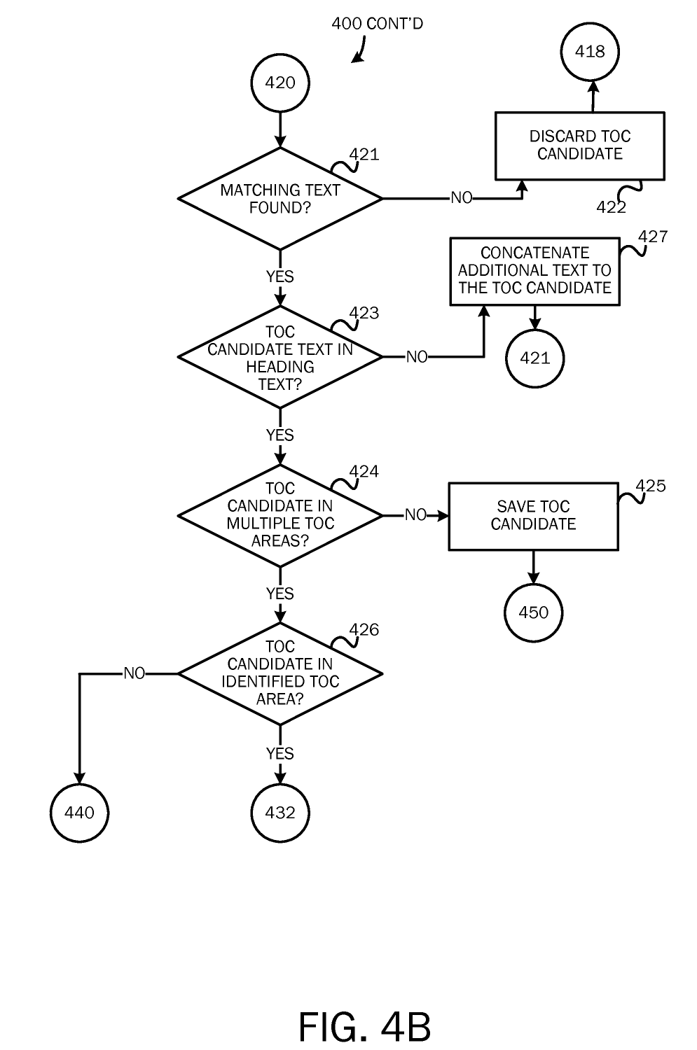

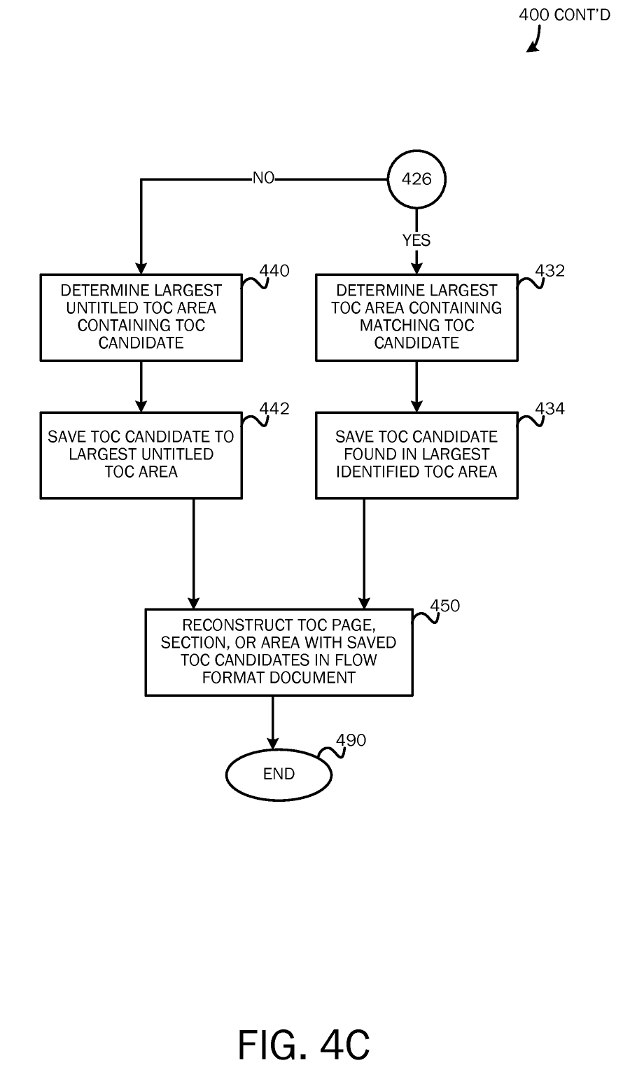

FIGS. 4A, 4B and 4C illustrate a flow chart showing one embodiment of a table of contents detection and reconstruction method 400 executed by a table of contents detection engine 122 in association with the fixed format detection and flow format reconstruction engine 120 for detecting table of contents entries in a fixed format document and for reconstructing the table of contents entries in an associated flow format document. As briefly described above, according to embodiments, after detection of TOC entries in a table of contents page, section or area of a fixed format document, the detected entries are used to improve detection of headings in the fixed format document, for example, by finding headings on pages in the fixed format document corresponding to page numbers associated with detected table of contents entries. During reconstruction of the fixed format document into a flow format document, the detected table of contents page, section or area may be replaced with a single “smart field” which may, in turn, be populated with headings collected from the fixed format document to create a reconstructed table of contents page, section or area.

Referring then to FIGS. 4A, 4B and 4C, the method 400 begins at start operation 402 and proceeds to operation 406 where a fixed format document having a table of contents page, section or area is received for analysis and for detection of table of contents entries and for reconstructing the fixed format document into a flow format document where the table of contents entries are reconstructed in the flow format document.

At operation 408, line and paragraph detection are performed by the fixed format detection and reconstruction engine 120 for separating the received fixed format document into one or more individual lines and paragraphs that may be further analyzed for detecting table of contents entries, as described herein. At operation 410, lines containing table of contents entry attributes are detected by the table of contents detection engine 122. According to an embodiment, the table of contents detection engine 122 parses each detected line and analyzes each detected line for attributes of table of contents entries, as illustrated and described above with reference to FIGS. 3A through 3C. For example, the table of contents detection engine 122 looks for lines containing a heading, followed by a space of separation, followed by one or more alphanumeric page indicators. As should be appreciated, the table of contents detection engine 122 may look for headings as a discrete selection of text including one or more words, followed by a separation of space, followed by an indication of a page number.

For the alphanumeric page indicator, the table of contents detection engine 122 may look for any number of numeric page indicators, for example, “1, 2, 3, etc.”, or the table of contents detection engine may look for one or more alphabetical page indicators, for example, “a, b, c, etc.”, or the table of contents detection engine 122 may look for page indicators of other types, for example, roman numerals, or other types of alphanumeric indicators that may be used for indicating a page on which associated headings and/or text may be located. That is, the TOC detection engine 122 may look for page indicators as any of a variety of alphanumeric indicators used according to different languages and text types.

As should be appreciated, in some cases a given table of contents entry may include a table of contents heading, but may not include space separators and page indicators. For example, a given document may include multiple tables of contents pages, sections, or areas. For example, a summary table of contents may include a listing of a subset of the headings contained in a document without listing associated page numbers on which the headings may be found in the associated document. A secondary table of contents may include a listing of all headings and subheadings along with page numbers on which the headings and/or subheadings and associated text may be found.

According to an embodiment, during the process of finding lines that may be table of contents entry candidates, the table of contents detection engine 122 may perform the search based on the text orientation of the received text. For example, if it is known that the received document was written in a left-to-right orientation, for example, as written in English, then the table of contents detection engine may look for table of contents entry candidates according to a left-to-right text rendering orientation. On the other hand, if it is known that the document was rendered according to a right-to-left orientation, then the table of contents detection engine 122 may analyze the text according to a right-to-left orientation. According to one embodiment, a given fixed format document may contain a mixture of left-to-right and right-to-left oriented text. Because of this possibility, the table of contents detection engine 122 may search for TOC entry candidates on a line-by-line basis where the text orientation of each line is considered as opposed to the orientation of the document. If the origin of the document and associated text rendering orientation is not known, then the table of contents detection engine 122 may analyze the text according to both orientations.

At operation 412, the table of contents detection engine 122 attempts to identify a table of contents page, section or area 300 in the received fixed format document. As described above, a table of contents page, section or area 300 often includes a heading or title, for example “Table of Contents,” or “Contents,” or “Table of Headings,” or “Headings,” or the like. The table of contents detection engine 122 may look for such text for determining whether a given page or pages includes table of contents entries associated with a table of contents page, section or area. As should be appreciated, this heuristic analysis may be important when multiple TOC candidates (e.g., from multiple TOC pages, sections or areas) are found, and thus, this heuristic may be used for determining which TOC entry is the best or right entry, as discussed further below.

Determining whether a particular page or pages is/are associated with a table of contents for the received document will assist the table of contents detection engine in determining whether entries contained therein are in fact table of contents entries. As should be appreciated, if no such table of contents title or heading is available, the table of contents detection engine 122 may continue with the process of affirmatively detecting table of contents entries, but a detection of a particular page or pages as a table of contents page, section or area will assist in and improve the confidence associated with the detection of table of contents entries.

At operation 414, the table of contents detection engine generates one or more table of contents entry candidates for detection and potential use in reconstruction of a table of contents page, section or area in a reconstructed flow format document. At operation 416, the table of contents detection engine 122 groups together one or more lines of potential table of contents entry lines as potential table of contents candidates. According to an embodiment, lines that end with successive page numbers in the same numbering schemes may be grouped together. For example, consider the following lines found in a TOC page, section or area:

Heading 1 . . . i

Heading 2 . . . iii

Heading 3 . . . iv

Heading 4 . . . 1

Heading 5 . . . 5

Heading 6 . . . 6

Heading 7 . . . 3

Heading 8 . . . 7

According to this example, the table of contents detection engine 122 may find three TOC candidates: (1) first three lines as a first TOC candidate; (2) the second three lines as a second TOC candidate; and (3) the remaining two lines as a third candidate. Continuing with this example, later the TOC detection engine 122 may put together the first and second TOC candidates or other combinations which may be the case in a given document to use one scheme at the beginning of a document and another scheme in the rest of the document.

Referring back to FIG. 3A, the table of contents detection engine 122 may utilize information about the display of the suspected table of contents entries for generating table of contents candidate groupings. For example, referring to FIG. 3A, the engine 122 may detect space between the table of contents title 310 and the first table of contents entry 315 followed by line spaces between the first table of contents entry 315 and the second table of contents entry 330. Thus, the engine 122 may create a first table of contents entry candidate using the heading 316 comprising the first table of contents entry 315. Likewise, owing to line spacing between the first table of contents entry 315 and the second table of contents entry 330, followed by line spacing between the second table of contents entry 330 and the third table of contents entry 335, the table of contents detection engine may identify the heading 331 comprising the second table of contents entry 330 as a second table of contents entry candidate.

Next, the table of contents detection engine 122 may generate a number of table of contents entry candidates from the table of contents entry 335 illustrated in FIG. 3A. For example, a first table of contents entry candidate may include the first line “Quick Brown Fox” only of the table of contents entry 335. A second table of contents candidate may include the first two lines “Quick Brown Fox Is Not As Quick” of the table of contents entry 335, and a third table of contents entry candidate may include all three lines of the table of contents entry 335. By generating multiple table of contents entry candidates from each of the lines parsed from the fixed format document, the table of contents detection engine may compare each of the table of contents entry candidates with headings, subheadings, and related text found in the received fixed format document for isolating correct table of contents entries. As should be appreciated, if no line spacing is included between table of contents entries 315, 330, 335, 340, then the table of contents detection engine may create a number of table of contents entry candidates from different combinations of lines rendered before and after suspected table of contents entries.

Referring still to the example TOC items in FIG. 3A, according to one embodiment, the TOC detection engine 122 may find only one TOC candidate with some lines before and/or after TOC items. A third TOC item may have heading text of “as a wolf” at the beginning. But, when the TOC detection engine 122 is attempting to match heading text with heading paragraphs on page of the fixed format document, as described below, the engine 122 will determine that it cannot match only “as a wolf” with a heading on the page. In response, it we will concatenate this heading text with lines before and/or after the TOC candidate (in this case there are two lines—“Quick Brown Fox” and “is Not as Quick”), and then the engine 122 will attempt to match the concatenated lines with a heading on the subject page again.

Referring now to operation 418, the table of contents detection engine 122 retrieves a first table of contents entry candidate for analysis against the received fixed format document. At operation 420, the table of contents detection engine 122 retrieves the page number, if available, from the end of one of the lines of the retrieved table of contents entry candidate as illustrated and described above with reference to FIG. 3A, and the engine 122 parses the received fixed format document for text matching the table of content entry candidate. In order to locate text matching the table of contents entry candidate, the engine 122 locates a page in the received fixed format document matching the page number associated with the table of contents entry candidate being analyzed.

In order to locate a page that may contain matching text, the table of contents detection engine 122 may use one or more of a variety of different methods. According to one embodiment, the TOC engine 122 may use pattern matching for detecting page numbers on pages of the fixed format document and for detecting headings that may be compared against each table of contents candidate. That is, if the TOC engine 122 needs to check page 3 of a fixed format document to determine whether a given heading is located on that page, then the TOC engine 122 may use pattern matching for locating the page and for subsequently attempting to locate a heading matching a given TOC entry candidate. For example, referring to FIG. 3A, the first table of contents entry 315 is illustrated in association with a page number 3, and thus, the detection engine 122 may attempt to find text on page 3 of the received fixed format document matching text contained in a text entry candidate created from the first text entry 315, illustrated in FIG. 3A. As should be appreciated, page numbers on each of the pages of the received fixed format document may be located by the detection engine 122 when each line of the received fixed format document is identified at operation 408. According to an embodiment, if page numbers are not rendered on each page of the received fixed format document, the detection engine 122 may use other methods, for example, a method of counting each page in the received fixed format document followed by assigning temporary page numbers to each page that may be used for comparing against page numbers associated with potential table of contents entries.

At operation 421, a determination is made by the detection engine 122 as to whether text matching the first table of contents entry candidate is found on a page in the received fixed format document. If no text matching the first table of contents entry candidate is found in the fixed format document, the method proceeds to operation 422, and the candidate is discarded at operation 422. If the first analyzed table of contents entry candidate is discarded at operation 422, the method proceeds back to operation 418, and the next table of contents entry candidate is retrieved for analysis.

Referring back to operation 421, if text is found in the received fixed format document matching the retrieved table of contents entry candidate, the method proceeds to operation 423, and a determination is made as to whether the text found in the fixed format document matching text in the first table of contents entry candidate is in heading text located on the page associated with the first analyzed table of contents entry candidate. For example, referring to FIG. 3A, if a table of contents entry candidate comprised of the first two lines of the table of contents entry 335 is found to have text matching a heading located on page 4 of the received document, then while matching text may be found on page 4 of the document, at operation 423, a determination will be made that the analyzed text does not match the heading text found on page 4 of the document.

As illustrated in FIG. 3C, the heading text 370 found on page 4 includes all three lines of the associated table of contents entry 335, and thus, the analyzed text containing only the first two lines of the table of contents entry 335 will not match the heading text 370 rendered on page 4 of the document. Thus, the method fails at operation 423, and proceeds to operation 427. At operation 427, the TOC detection engine 122 will attempt to concatenate additional lines before and/or after the present TOC candidate, and proceed back to operation 421 where the revised TOC candidate is matched against the text on the analyzed page for a matching heading. That is, the present TOC candidate is revised by adding lines before or after the present TOC candidate as detected in the TOC page, section or area. According to one embodiment, a given TOC candidate may also be revised by splitting it into different combinations of lines. Thus, false positives are filtered out by requiring that heading text to be found on the page corresponding to the page number contained at the end of the TOC entry.

Referring still to operation 423, if the analyzed table of contents entry candidate text does match exactly the heading text found in the received fixed format document, the method proceeds to operation 424, and a determination is made as to whether the table of contents entry candidate is found in more than one table of contents page, section or area. As described above, in some cases, a given document may include more than one table of contents page, section or area, and likewise, a given heading may be listed in multiple locations in a given document. If at operation 424 a determination is made that the analyzed table of contents entry candidate is found in only one table of contents page, section or area, then the method proceeds to operation 425, and the candidate is saved and the heading found in the fixed format document matching a heading contained in the TOC candidate is designated for eventual reconstruction in the desired flow format document.

If at operation 424, the table of contents entry candidate is found in more than one table of contents page, section or area, the method proceeds to operation 426, and a determination is made as to whether the table of contents entry candidate is found in multiple pages, sections or areas identified as table of contents pages, sections or areas, for example, where a table of contents title 310 is found on each of the multiple pages, sections or areas. If so, the method proceeds to operation 432, and a determination is made as to which of the table of contents pages, sections or areas is the largest. At operation 434, the table of contents entry candidate associated with the largest of the table of contents pages, sections or areas is saved and the heading found in the fixed format document matching a heading contained in the TOC candidate is designated for eventual use in reconstructing the desired flow format document.

Referring back to operation 426, if the analyzed table of contents entry candidate is not found on a page, area or section readily identifiable as a table of contents page, section or area (as identified by a table of contents title 310), the method proceeds to operation 440, and a determination is made as to the largest of the table of content item sets (containing table of contents entry candidates) containing the matching table of contents entry candidate. The method proceeds to operation 442, and the matching table of contents entry candidate contained in the largest of the table of content item sets is saved and the heading found in the fixed format document matching a heading contained in the TOC candidate is designated for eventual reconstruction in the desired flow format document.

At operation 450, any heading found in the fixed format document matching a heading contained in the table of content entry candidate designated and saved for inclusion in a reconstructed flow format document, is utilized by the table of contents detection engine 122 for reconstructing a table of contents page, section or area, containing one or more reconstructed table of contents entries in a reconstructed flow format document. According to an embodiment, reconstruction of the table of contents page, section or area includes locating a position of the detected table of contents page, section or area and replacing all the lines and/or paragraphs in that TOC page, section or area with a single “smart field.” Then, all the collected headings that matched TOC candidates are populated into the smart field to create a TOC page, section or area in the resulting flow format document. The method 400 ends at operation 490.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

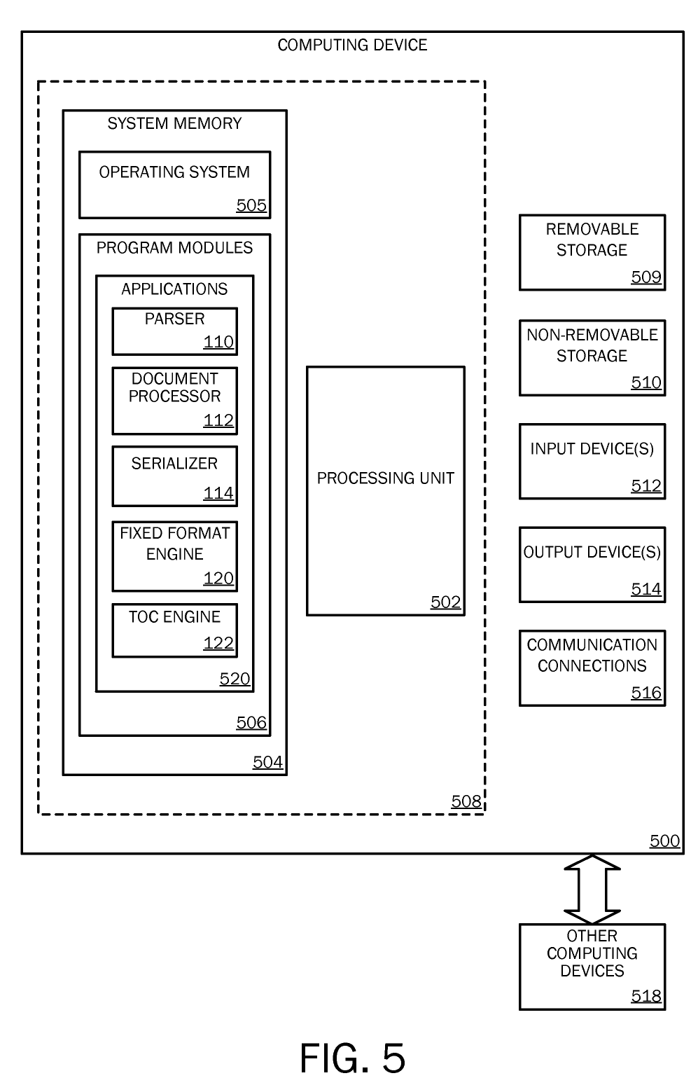

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating physical components (i.e., hardware) of a computing device 500 with which embodiments of the invention may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 520 such as the fixed format detection and flow format reconstruction engine 120 and the table of contents detection and reconstruction engine 122, the document processor 112, the parser 110, the document converter 102, and the serializer 114. The operating system 505, for example, may be suitable for controlling the operation of the computing device 500. Furthermore, embodiments of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., the fixed format detection and flow format reconstruction engine 120, the table of contents detection and reconstruction engine 122, the parser 110, the document processor 112, and the serializer 114) may perform processes including, but not limited to, one or more of the stages of the method 400 illustrated in FIG. 4. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the fixed format detection and flow format reconstruction engine 120, the table of contents detection and reconstruction engine 122, the parser 110, the document processor 112, and the serializer 114 may be operated via application-specific logic integrated with other components of the computing device 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communication media. Computer storage media may include volatile and nonvolatile, removable and non-removable media implemented in any method or technology for storage of information, such as computer readable instructions, data structures, program modules, or other data. The system memory 504, the removable storage device 509, and the non-removable storage device 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

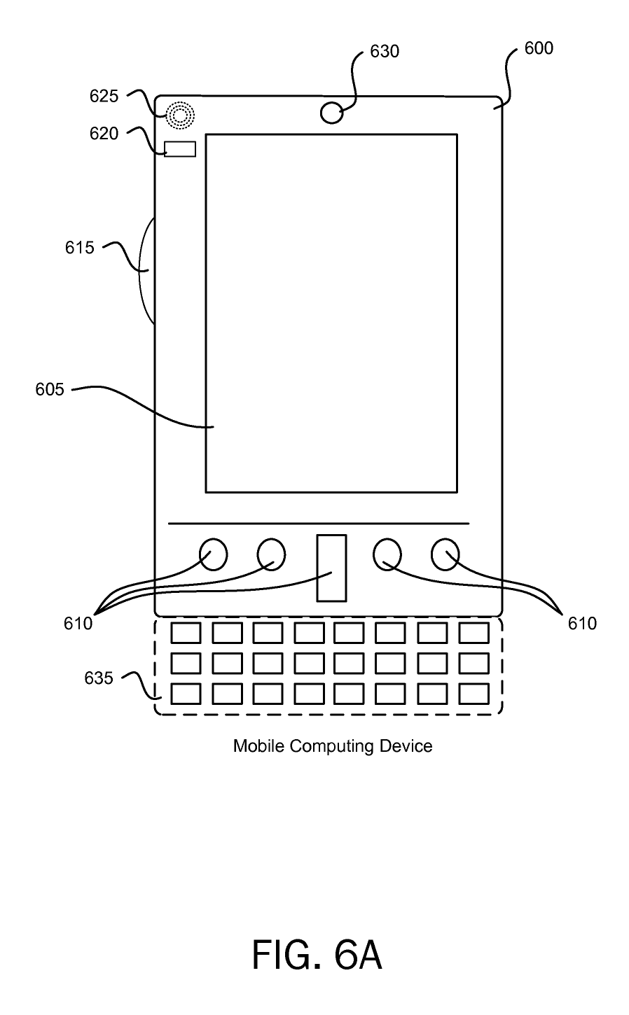

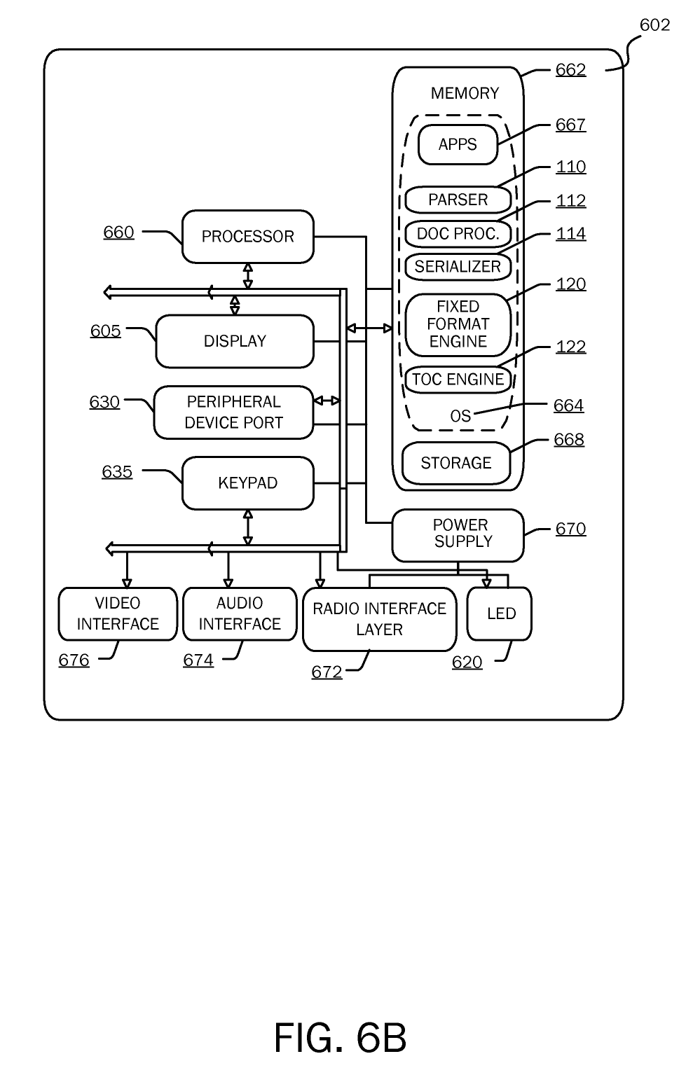

FIGS. 6A and 6B illustrate a mobile computing device 600, for example, a mobile telephone, a smart phone, a tablet personal computer, a laptop computer, and the like, with which embodiments of the invention may be practiced. With reference to FIG. 6A, one embodiment of a mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 667 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 667 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including the fixed format detection and flow format reconstruction engine 120, the table of contents detection and reconstruction engine 122, the parser 110, the document processor 112, and the serializer 114 described herein.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 667 via the operating system 664, and vice versa.

The radio 672 allows the system 602 to communicate with other computing devices, such as over a network. The radio 672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 602 provides notifications using the visual indicator 620 that can be used to provide visual notifications and/or an audio interface 674 producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668. Computer storage media may include volatile and nonvolatile, removable and non-removable media implemented in any method or technology for storage of information, such as computer readable instructions, data structures, program modules, or other data.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

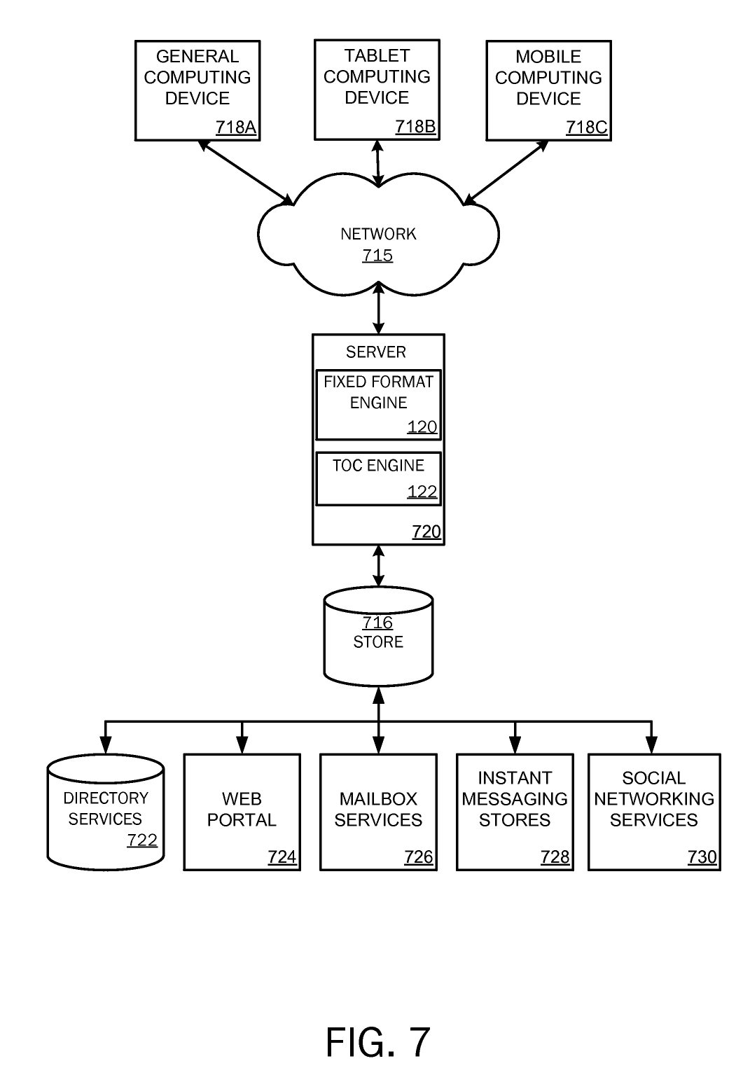

FIG. 7 illustrates one embodiment of the architecture of a system for providing table of contents detection in a fixed format document 106 to one or more client devices, as described above. Content developed, interacted with, or edited in association with the fixed format detection and flow format reconstruction engine 120, the table of contents detection and reconstruction engine 122, the parser 110, the document processor 112, and the serializer 114 may be stored in different communication channels or other storage types. For example, various documents may be stored using a directory service 722, a web portal 724, a mailbox service 726, an instant messaging store 728, or a social networking site 730. The fixed format detection and flow format reconstruction engine 120, the table of contents detection and reconstruction engine 122, the parser 110, the document processor 112, and the serializer 114 may use any of these types of systems or the like for enabling data utilization, as described herein. A server 720 may provide the fixed format detection and flow format reconstruction engine 120, the table of contents detection and reconstruction engine 122, the parser 110, the document processor 112, and the serializer 114 to clients. As one example, the server 720 may be a web server providing the fixed format detection and flow format reconstruction engine 120, the table of contents detection and reconstruction engine 122, the parser 110, the document processor 112, and the serializer 114 over the web. The server 720 may provide the fixed format detection and flow format reconstruction engine 120, the table of contents detection and reconstruction engine 122, the parser 110, the document processor 112, and the serializer 114 over the web to clients through a network 715. By way of example, the client computing device 718 may be implemented as the computing device 500 and embodied in a personal computer 718a, a tablet computing device 718b and/or a mobile computing device 718c (e.g., a smart phone). Any of these embodiments of the client computing device 718 may obtain content from the store 716.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method of detecting table of contents entries in a fixed format document; comprising:
detecting one or more lines in the fixed format document containing one or more attributes of a table of contents entry;
generating a table of contents entry candidate from the one or more lines in the fixed format document containing one or more attributes of a table of contents entry;
comparing the table of contents entry candidate with text contained in the fixed format document for finding a heading contained in the fixed format document matching a heading contained in the table of contents entry candidate; and
if a heading contained in the table of contents entry candidate matches a heading contained in the fixed format document, designating the heading contained in the fixed format document matching the heading contained in the table of contents entry candidate for reconstruction in a flow format document.

2. The method of claim 1, prior to detecting one or more lines in the fixed format document containing one or more attributes of a table of contents entry, detecting a table of contents area containing the one or more lines in the fixed format document containing one or more attributes of a table of contents entry.

3. The method of claim 2, further comprising replacing the table of contents area with a smart field for receiving the heading contained in the fixed format document matching the heading contained in the table of contents entry candidate designated for reconstruction in a flow format document.

4. The method of claim 1, prior to detecting one or more lines in the fixed format document containing one or more attributes of a table of contents entry, receiving a fixed format document for reconstruction as a flow format document.

5. The method of claim 1, wherein detecting one or more lines in the fixed format document containing one or more attributes of a table of contents entry includes detecting one or more lines in the fixed format document containing a heading.

6. The method of claim 5, further comprising detecting one or more lines in the fixed format document containing a page number.

7. The method of claim 6, further comprising detecting one or more lines in the fixed format document containing one or more space separators between the heading and the page number.

8. The method of claim 1, wherein generating a table of contents entry candidate includes grouping together one or more lines in the fixed format document containing one or more attributes of a table of contents entry.

9. The method of claim 1, wherein comparing the table of contents entry candidate with text contained in the fixed format document further comprises searching for a heading in the text contained in the fixed format document matching a heading contained in the table of contents entry candidate.

10. The method of claim 9, wherein searching for a heading in the text contained in the fixed format document matching a heading contained in the table of contents entry candidate includes retrieving a page number from the table of contents entry candidate and searching a page in the fixed format document corresponding to the page number retrieved from the table of contents entry candidate.

11. The method of claim 1, wherein if a heading contained in the table of contents entry candidate does not match a heading contained in the fixed format document, further comprising:
modifying the table of contents entry candidate by concatenating one or more table of contents entry items to the heading contained in the table of contents entry candidate; and
if the concatenated heading contained in the table of contents entry candidate matches a heading contained in the fixed format document, designating the concatenated heading contained in the fixed format document matching the heading contained in the table of contents entry candidate for reconstruction in a flow format document.

12. The method of claim 1, further comprising determining whether an identified table of contents area is contained in the fixed format document.

13. The method of claim 12, wherein determining whether an identified table of contents area is contained in the fixed format document includes determining whether a table of contents title is contained in a table of contents area that identifies the table of contents area as an identified table of contents area.

14. The method of claim 13, further comprising determining whether a table of contents entry candidate designated for reconstruction in a flow format document is contained in more than one identified table of contents area.

15. The method of claim 14, wherein if the table of contents entry candidate designated for reconstruction in a flow format document is contained in more than one identified table of contents area, designating the table of contents entry candidate for reconstruction in a reconstruction of a largest of the more than one identified table of contents area.

16. The method of claim 1, further comprising determining whether the table of contents candidate designated for reconstruction in a flow format document is contained in more than one area of the fixed format document containing table of contents entry candidates.

17. The method of claim 16, wherein if the table of contents entry candidate designated for reconstruction in a flow format document is contained in more than one area of the fixed format document containing table of contents entry candidates, designating the table of contents entry candidate for reconstruction in a reconstruction of a largest of the more than one area of the fixed format document containing table of contents entry candidates.

18. A computer readable medium containing computer executable instructions which when executed by a computer perform a method of detecting table of contents entries in a fixed format document for reconstructing a flow format document; comprising:
detecting one or more lines in the fixed format document containing one or more attributes of a table of contents entry, the one or more attributes including one or more of a heading, a page number and a space separator separating the heading and page number;
detecting a table of contents area containing the one or more lines in the fixed format document containing one or more attributes of a table of contents entry;
generating a table of contents entry candidate from the one or more lines in the fixed format document containing one or more attributes of a table of contents entry;
comparing the table of contents entry candidate with text contained in the fixed format document for finding a heading contained in the fixed format document matching a heading contained in the table of contents entry candidate;
if a heading contained in the table of contents entry candidate matches a heading contained in the fixed format document, designating the heading contained in the fixed format document matching the heading contained in the table of contents entry candidate for reconstruction in a flow format document; and
replacing the table of contents area with a smart field for receiving the table of contents entry candidate designated for reconstruction in a flow format document.

19. A system for detecting table of contents entries in a fixed format document; comprising:
one or more processors; and
a memory coupled to the one or more processors, the one or more processors operable to:
detect one or more lines in the fixed format document containing one or more attributes of a table of contents entry;
generate a table of contents entry candidate from the one or more lines in the fixed format document containing one or more attributes of a table of contents entry;
compare the table of contents entry candidate with text contained in the fixed format document for finding a heading contained in the fixed format document matching a heading contained in the table of contents entry candidate;
designate the heading contained in the fixed format document matching the heading contained in the table of contents entry candidate for reconstruction in a flow format document; and
replace a table of contents area contained in the fixed format document with a smart field for receiving the heading contained in the fixed format document matching the heading contained in the table of contents entry candidate.

20. The system of claim 19, the one or more processors being further operable to:
determine whether the heading designated for reconstruction in a flow format document is contained in more than one identified table of contents area; and
designate the heading for reconstruction in a reconstruction of a largest of the more than one identified table of contents area if the heading designated for reconstruction in a flow format document is contained in more than one identified table of contents area.
